(19) United States
(12) Patent Application Publication
(10) Pub. No.: US 2004/0004850 A1
(43) Pub. Date: Jan. 8, 2004

(54) Portable, compact and attachable power supply device

(76) Inventor: Lawrence J. Frank, Bothell, WA (US)

Correspondence Address: Mr. Lawrence J Frank, 1033 207 PL SE, Bothell, WA, 98012, US

(21) Appl. No.: 10/189,067

(22) Filed: Jul. 3, 2002

(51) Int. Cl. H02M 3/18

(52) U.S. Cl. 363/59

(57) ABSTRACT

A portable, compact and attachable power supply device is disclosed for electrically powering a variety of external units. The power supply device comprises a body having a battery or cell compartment in side one and side two, disposed therein. Said compartments are configured in series for conventional, disposable or rechargeable batteries or cells. A separate removable cover is provided for each said compartment, and a water resistant seal is disposed along the edges of said compartments. A switch is disposed on the top center portion of said body for selecting or terminating power from said compartments to, an output socket disposed on the top front portion of power supply body. An indicator light is configured between said switch and said socket. A cover plug with a moisture resistant seal, is also disposed on the top front portion for inserting into said socket as a safety feature. An attaching mechanism is disposed on side two for mounting power supply body to an article of clothing or structure.

### FEDERALLY SPONSORED RESEARCH

Not Applicable

### SEQUENCE LISTING

Not Applicable

### FIELD OF INVENTION

The present invention relates to a power supply device, more particularly to a portable, compact and attachable power supply that is useful to supply power to a variety of units that can communicate power from a vehicles cigarette lighter socket.

### BACKGROUND OF INVENTION

A variety of different power supplies are currently available. Such power supplies are typically configured to communicate power to a single proprietary unit, and may be too cumbersome due to size, weight and the absence of a convenient attaching mechanism. Thus, the user must purchase and carry a power source separate and apart from the various units to be powered, e.g. a cell phone or portable navigation unit. Additionally some power supplies may require the inconvenience of a lengthy charge time, and access to an AC or DC outlet. The cost of the unit and or replacement of the internal power source can be a deterrent, due to their proprietary nature, e.g. a web site or single retail store. Additionally there needs to exist a power supply device that can address the ability to have a power source that can interchange with other conventional battery powered devices, thus limiting the number of batteries a user must carry. And due to the wide variety of retail stores that stock conventional batteries, a user would not need to pack batteries, thus decreasing their travel weight until the power supply device is needed.

### OBJECTS AND ADVANTAGES

(a) to provide a power supply that can communicate power to any unit that can use a cigarette lighter outlet or socket as a power source:

(b) to provide a power supply that has the option of using four or eight batteries, by either installing only four or eight batteries or by using a switch to select six or twelve VDC.

(c) to provide a power supply that can be carried outside and is protected from moisture, thus providing a safe and reliable power source when needed; e.g. camping, hiking.

(d) to provide a power supply that can be worn on the body to improve hands free and mobile operation of a unit being powered; e.g. cell phone or navigation unit.

(e) to provide a universal power supply that is inexpensive.

The present invention is intended to address these and other deficiencies commonly found in portable power supplies, resulting in a product that is not only functional to power a variety of different units, but which is also cost effective, convenient and practical to use.

### SUMMARY

A portable, compact and attachable power supply device is disclosed for electrically powering a variety of external units. The power supply device comprises a body having a battery or cell compartment in side one and side two, disposed therein. Said compartments are configured in series for conventional, disposable or rechargeable batteries or cells. A separate removable cover is provided for each said compartment, and a water resistant seal is disposed along the edges of said compartments. A switch is disposed on the top center portion of said body for selecting or terminating power from said compartments to, an output socket disposed on the top front portion of power supply body. An indicator light is configured between said switch and said socket. A cover plug with a moisture resistant seal is also disposed on the top front portion for inserting into said socket as a safety feature. An attaching mechanism is disposed on side two for attaching power supply body to an article of clothing or structure.

### BRIEF DESCRIPTION OF THE DRAWINGS

FIG. 1 is an angled front and top perspective view of a portable, compact and attachable power supply formed in accordance with the present invention;

FIG. 2 is a rear perspective view of the power supply shown in FIG. 1;

FIG. 3 is an angled front and top perspective view of the power supply with all covers installed.

FIG. 4 is a rear perspective view with all covers installed.

FIG. 5 is perspective views of the invention showing possible separate interconnected units.

### DETAILED DESCRIPTION OF THE PREFERRED EMBODIMENT

The description set fourth below in connection with the appended drawings is intended merely as a description of the presently preferred embodiments of the invention, and is not intended to represent the only form in which the present invention may be constructed or utilized. The description sets fourth the functions and sequence of steps for construction and implementation of the invention in connection with the illustrated embodiments. It is to be understood, how ever, that the same or equivalent functions and sequences may be accomplished by different embodiments that are also intended to be encompassed within the spirit and scope of the invention.

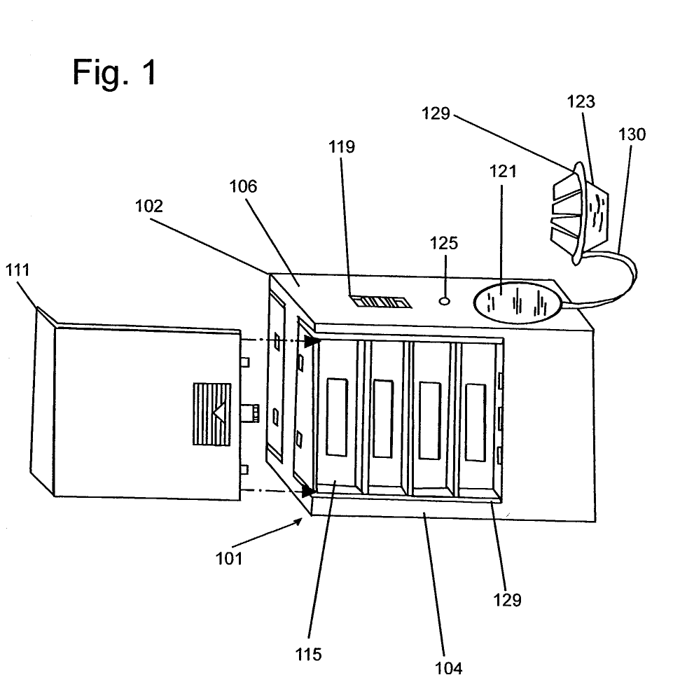

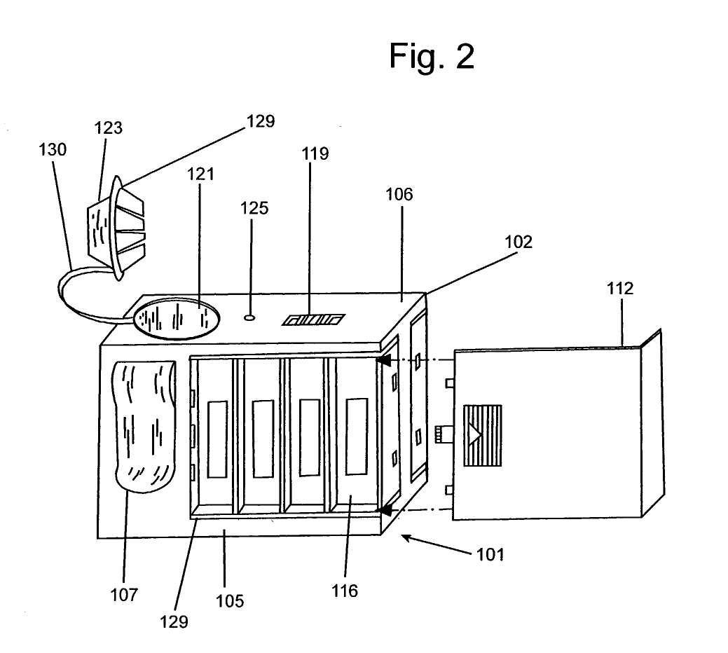

FIGS. 1 and 2 are perspective views of a portable compact and attachable power supply 101 formed in accordance with the present invention, with cover plug and socket, and battery or cell compartments and covers in an exposed configuration. As shown therein the compact power supply 101 includes a body 102 having side portions 104,105, top portion 106 and an attaching portion 107. A separate internal battery or cell compartment 115,116, configured in series is disposed within side portions 104,105 of power supply body 101, which may house conventional disposable or rechargeable batteries or cells. The output power from said compartments 115,116, is typically 6 VDC or 12 VDC selected or terminated by a switch 119, located on the top portion 106 of power supply body 101, the output from the switch 119 when selected, may be communicated to an output socket 121 located on the top portion 106 of power supply body 101, when not in use the socket 121 is protected by a cover plug 123 which inserts into socket 121 to seal out moisture and is attached to body 102 by a flexible band 130. Additionally an indicator light is installed on top portion 106, between switch 119 and socket 121, operative to indicate if power is being communicated from compartments 115,116, to socket 121. The battery or cell compartments may be enclosed by aligning and sliding compartment covers 111,112, toward socket 121 until covers latch into place, and are then removed by depressing and sliding away from socket 121. Additionally a moisture resistant seal 129 is disposed along the edges of compartments 115,116, and around the inserting edge of cover plug 123. Attaching portion 107 is disposed on side portion 104 forward of battery compartment 116, a clip is disposed on the attaching portion 107 of power supply body 102, functional to engage an article of clothing such as a belt or similar structure to facilitate mobility and convenience.

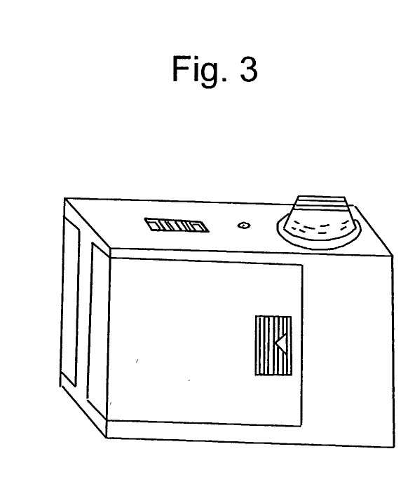

FIG. 3 is an angled perspective view of front side portion 104 and top portion 106 of the power supply 101 with compartment cover 111 and cover plug 123 installed on body 102.

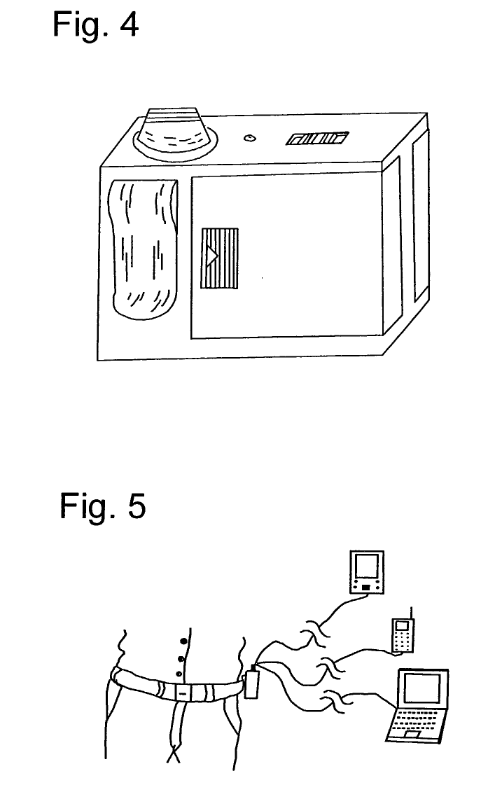

FIG. 4 is an angled perspective view of rear side portion 105 and top portion 106 of the power supply 101 with compartment cover 112 and cover plug 123 installed on body 102.

FIG. 5 is a perspective view of power supply 101 attached to a waist belt with possible separate interconnection units e.g., a global positioning unit, cell phone, or mobile computer. As will be recognized by those skilled in the art, the internal circuitry, battery or cell capacity, power output, indicator light, attaching mechanism and switch of the power supply 101, may be selected or varied as convenient without departing from the broader aspects of the invention. Additionally it should be understood that the power supply 101 may be used in conjunction with a variety of different units in addition to those illustrated in FIG. 5.

What is claimed is:

1. A portable, compact and attachable power supply device for electrically powering a variety of external units, comprising:
a power supply body having a battery or cell compartment disposed in side one, and in side two, a top portion, and an attaching portion;
a separate removable cover for each said compartment, said cover being operative in the accessing and sealing of said compartments; and
a switch is disposed on the body top portion; said switch is operative for selecting or terminating power from said compartments to;
an output socket disposed on the body top front portion for communicating power to an external unit. Also a removable cover plug is disposed on said socket; and
an indicator light is disposed on the body top portion; said light is operative in the indication of the power communicating to socket from said compartments; and
an attaching mechanism is disposed on the attaching portion.

2. The power supply device as in claim 1 wherein said compartments are substantially the same in construction, and are configured in series.

3. The power supply device as in claim 1 wherein a seal is provided along the outer edges of each said compartment, to resist moisture from entering when said removable covers are installed over said compartments.

4. The power supply device as in claim 1 wherein the output socket is similar in construction to a vehicle cigarette lighter socket.

5. The power supply device as in claim 1 wherein the “cover plug” is configured with a seal around the lower portion, to resist moisture from entering said socket when inserted, and to provide a safety feature.

6. The power supply device as in claim 1 wherein said switch can be selected to communicate, or terminate power from both said compartments, or only one compartment, to output socket.

7. The power supply device as in claim 1 wherein an attaching mechanism is configured on the attaching portion side two of said body, and can be mounted on side one of body, for mounting said body on an article of clothing or a structure.
